(19) United States
(12) Patent Application Publication
(10) Pub. No.: US 2019/0112732 A1
(43) Pub. Date: Apr. 18, 2019

(54) PROPYLENE BASED FILAMENT FOR 3D PRINTER

(71) Applicant: BASELL POLIOLEFINE ITALIA S.R.L., MILANO (IT)

(72) Inventors: ROBERTO DE PALO, FERRARA (IT); CLAUDIO CAVALIERI, FERRARA (IT)

(73) Assignee: BASELL POLIOLEFINE ITALIA S.R.L., MILANO (IT)

(21) Appl. No.: 16/094,647

(22) PCT Filed: Mar. 20, 2017
(86) PCT No.: PCT/EP2017/056495

§ 371 Date: Oct. 18, 2018

(30) Foreign Application Priority Data
Apr. 22, 2016 (EP) 16166589.8

(51) Int. Cl. D01F 6/30; C08F 210/06

(52) U.S. Cl. CPC D01F 6/30; C08F 210/16; C08F 210/06

(57) ABSTRACT

The present disclosure provides a filament for use in an extrusion-based additive manufacturing system made from or containing a propylene ethylene copolymer having: ethylene derived units content ranging from about 3.0 wt % to about 12.0 wt %, based upon the weight of the propylene ethylene copolymer; MFR L (Melt Flow Rate according to ISO 1133, condition L, at 230° C. and 2.16 kg load) from about 4 to about 20 g/10 min; and xylene solubles measured at 25° C. from about 3 wt % to about 30 wt %, based upon the weight of the propylene ethylene copolymer. The disclosure further provides an extrusion-based additive manufacturing system made from or containing the filament as well as 3D printed articles prepared from the system.

### FIELD OF THE INVENTION

In general, the present disclosure relates to the field of chemistry. More specifically, the present disclosure relates to polymer chemistry. In particular, the present disclosure relates to a filament made from or containing a propylene ethylene copolymer, for use in an extrusion-based 3D printer.

### BACKGROUND OF THE INVENTION

An extrusion-based 3D printer is used to build a 3D model from a digital representation of the 3D model in a layer-by-layer manner by extruding a flowable modeling material. A filament of the modeling material is extruded through an extrusion tip carried by an extrusion head, and is deposited as a sequence of roads on a substrate in an x-y plane. The extruded modeling material fuses to deposited modeling material, and solidifies upon a drop in temperature. The position of the extrusion head relative to the substrate is then incremented along a z-axis (perpendicular to the x-y plane), and the process is then repeated to form a 3D model resembling the digital representation. Movement of the extrusion head is performed under computer control, in accordance with build data that represents the 3D model. The build data is obtained by slicing the digital representation of the 3D model into multiple horizontally sliced layers. Then, for each sliced layer, the host computer generates a build path for depositing roads of modeling material to form the 3D model.

In the printing process, the filament changes the material of the filament, thereby changing the final mechanical and aesthetic properties of the finished object. In some instances, polylactic acid (PLA) or acrylonitrile, butadiene, styrene (ABS) polymer or polyamides are used for filaments.

It is desirable for the filament to have a constant diameter (in some instances, 1.75 mm or 3 mm); otherwise, finely tuning the amount of material in the printed object is challenging. It is difficult to achieve a constant diameter for the filament, which is believed to depend on the characteristics of the polymer.

It is further desirable that the filament be printable, which, as the term “printable” is used herein, means the filament achieves appropriate adhesion with the plate and among the layers.

### SUMMARY OF THE INVENTION

The present disclosure provides a filament for use in an extrusion-based additive manufacturing system made from or containing a propylene ethylene copolymer having:

ethylene derived units content ranging from about 3.0 wt % to about 12.0 wt %, based upon the weight of the propylene ethylene copolymer;

MFR L (Melt Flow Rate according to ISO 1133, condition L, at 230° C. and 2.16 kg load) ranging from about 4 to about 20 g/10 min; and

xylene solubles measured at 25° C. from about 3 wt % to about 30 wt %, based upon the weight of the propylene ethylene copolymer.

### BRIEF DESCRIPTION OF THE DRAWINGS

THE FIGURE is a front view of a sample used in print tests. The units of measure are mm. As shown, the printed sample was 5 mm thick.

### DETAILED DESCRIPTION OF THE INVENTION

In a general embodiment, the present disclosure provides a filament for use in an extrusion-based additive manufacturing system made from or containing a propylene ethylene copolymer having:

ethylene derived units content ranging from about 3.0 wt % to about 12.0 wt %; alternatively from about 3.5 wt % to about 10.0 wt %; alternatively from about 3.8 wt % to about 8.0 wt %, based upon the weight of the propylene ethylene copolymer;

MFR L (Melt Flow Rate according to ISO 1133, condition L, at 230° C. and 2.16 kg load) from about 4 to about 20 g/10 min, alternatively from about 5 to about 10 g/10 min; alternatively from about 6 to about 8 g/10 min; and

xylene solubles measured at 25° C. from about 3 wt % to about 30 wt %; alternatively from about 4 wt % to about 25 wt %, based upon the weight of the propylene ethylene copolymer.

As used herein, the term “copolymer” refers to polymer formed from only two monomers: propylene and ethylene.

In some embodiments, the propylene/ethylene copolymer is extruded in a filament having a constant diameter. In some embodiments, the diameter of the filament is about 1.75 mm or about 3 mm. In some embodiments, other diameters are used. In some embodiments, the variation from the nominal diameter is +/−0.05 mm, alternatively +/−0.03 mm. In some embodiments, the diameter of the filament is about 1.75 mm+/−0.05 mm or about 3 mm+/−0.05 mm. In some embodiments, the diameter of the filament is about 1.75 mm+/−0.03 mm or about 3 mm+/−0.03 mm.

It is believed that when amorphous polymeric materials are used, the polymeric materials have little or no ordered arrangements of their polymer chains in their solid states. It is believed that this lack of arrangements reduces the effects of curling and plastic deformation in the resulting 3D model or support structure. In some instances, the amorphous polymeric materials are acrylonitrile-butadiene-styrene (ABS) resins or polycarbonate resins.

While it is believed that crystalline or semicrystalline polymer can exhibit superior mechanical properties than amorphous polymers, it is also believed that crystalline or semicrystalline polymers show undesirable shrinkage effects both when the extruded road is deposited to form a portion of a layer of a 3D model and when the road is cooled. As such, it is further believed that the shrinkage effects renders the crystalline or semicrystalline polymers unsuitable for building 3D objects in an extrusion-based additive manufacturing process.

Contrary to the belief of persons of ordinary skill in the art, the present disclosure provides a semi-crystalline propylene ethylene copolymer suitable for building a 3D model.

Commercially-available examples of the propylene ethylene copolymer include (a) RP220M sold by LyondellBasell, (b) BOREALIS RD204 CF, and (c) LyondellBasell CLYRELL RC 1908.

In some embodiments, the filament is made from or contains additionally additives such as antioxidants, slipping agents, process stabilizers, antiacid and nucleants.

In some embodiments, the filament is made from or contains additionally fillers such as talc, calcium carbonate, wollastonite, glass fibers, glass spheres and carbon derived grades.

In some embodiments, the filament is made from or contains additionally wood powder, metallic powder, marble powder and similar materials.

The following examples are given to illustrate and not to limit the present invention.

### EXAMPLES

The data of the propylene polymer materials were obtained according to the following methods:

### Xylene-Soluble Fraction at 25° C.

The Xylene Soluble fraction was measured according to ISO 16152, 2005, but with the following deviations (between parentheses).

The solution volume was 250 ml (200 ml).

During the precipitation stage at 25° C. for 30 min, the solution, for the final 10 minutes, was kept under agitation by a magnetic stirrer (30 min, without any stirring at all).

The final drying step was done under vacuum at 70° C. (100° C.).

The content of the xylene-soluble fraction was expressed as a percentage of the original 2.5 grams and then, by difference (complementary to 100), the xylene unsoluble %.

### Ethylene (C2) Content

### ¹³C NMR of Propylene/Ethylene Copolymers

¹³C NMR spectra were acquired on a Bruker AV-600 spectrometer equipped with cryoprobe, operating at 160.91 MHz in the Fourier transform mode at 120° C.

The peak of the S_{ββ} carbon was used as internal reference at 29.9 ppm. (The nomenclature was according to C. J. Carman, R. A. Harrington and C. E. Wilkes, “Monomer Sequence Distribution in Ethylene-Propylene Rubber Measured by 13C NMR. 3. Use of Reaction Probability Mode,” 10 Macromolecules 536 (1977).) The samples were dissolved in 1,1,2,2-tetrachloroethane-d2 at 120° C. with a 8% wt/v concentration. Each spectrum was acquired with a 90° pulse, 15 seconds of delay between pulses and CPD to remove 1H-13C coupling. 512 transients were stored in 32K data points using a spectral window of 9000 Hz.

The assignments of the spectra, the evaluation of triad distribution and the composition were made according to Kakugo (M. Kakugo, Y. Naito, K. Mizunuma and T. Miyatake, “Carbon-13 NMR determination of monomer sequence distribution in ethylene-propylene copolymers prepared with δ-titanium trichloride-diethylaluminum chloride” 15 Macromolecules 1150 (1982)) using the following equations:

PPP=100T_{ββ}S PPE=100T_{βδ}S EPE=100T_{δδ}S

PEP=100S_{ββ}S PEE=100S_{βδ}S EEE=100(0.25 S_{γδ}+0.5 S_{δδ})/S

S=T_{ββ}+T_{βδ}+T_{δδ}+S_{ββ}+S_{βδ}+0.25 S_{γδ}+0.5 S_{δδ}

The molar percentage of ethylene content was evaluated using the following equation:

E % mol=100*[PEP+PEE+EEE]

The weight percentage of ethylene content was evaluated using the following equation:

$$E \% wt . = \frac{100 * E \% mol * M {W}_{E}}{E \% mol * M {W}_{E} + P \% mol * M {W}_{P}}$$

where P % mol is the molar percentage of propylene content, while MW_{E} and MW_{P} are the molecular weights of ethylene and propylene, respectively.

The product of reactivity ratio r₁r₂ was calculated according to Carman (C. J. Carman, R. A. Harrington and C. E. Wilkes, 10 Macromolecules 536 (1977)) as:

$${r}_{1} {r}_{2} = 1 + ( \frac{EEE + PEE}{PEP} + 1 ) ( \frac{P}{E} + 1 ) {( \frac{EEE + PEE}{PEP} + 1 )}^{0.5}$$

The tacticity of Propylene sequences was calculated as mm content from the ratio of the PPP mmT_{ββ}(28.90-29.65 ppm) and the whole Tpp (29.80-28.37 ppm)

### Melt Flow Rate (MFR)

The melt flow rate MFR of the polymer was determined according to ISO 1133 (230° C., 2.16 Kg).

The following polymers were used:

PP1

Propylene homopolymer having a MFR of 6.5 and a fraction soluble in xylene at 25° C. of <4 wt %, based upon the weight of the propylene homopolymer.

PP2

A filament of diameter 1.75 mm sold under the tradename PP REPRAP BLACK FILAMENT German RepRap PP Filament 600 g, made from or containing a random propylene ethylene copolymer having an ethylene content of 3 wt %, based upon the weight of the random propylene ethylene copolymer, an MFR of 2 dl/10 min, and a fraction soluble in xylene at 25° C. of 6.2 wt %, based upon the weight of the random propylene ethylene copolymer.

PP3

Propylene ethylene copolymer sold under the tradename MOPLEN RP220M being a random propylene ethylene copolymer having an ethylene content of 4 wt %, based upon the weight of the random propylene ethylene copolymer, an MFR of 7, and a fraction soluble in xylene at 25° C. of 7%, based upon the weight of the random propylene ethylene copolymer.

Polymers PP1 and PP3 were extruded to form a filament having 1.75 mm of diameter. Toextrude PP1, 10 wt % of talc, based upon the total weight of the composition, was added.

### Print Test

The printer was a 3D Rostock delta printer. The printer conditions were the followings:

| | | |
|---|---|---|
| Filament diameter | mm | 1.75 ± 0.03 |
| Nozzle diameter | mm | 0.4 |
| Temperature first layer | ° C. | 245 |
| Temperature other layers | ° C. | 245 |
| | | 1 |
| Layer high | mm | 0.2 |
| Temperature plate | ° C. | 100 |
| Support material to | | vinylic glue |
| adhere on the plate | | |
| Plate material. | | glass |
| Infill | | 100% |
| printer speed | mm/min | 3600 |
| Speed first layer | | 60% |
| Speed other layers | | 100% |
| Speed infill | mm/min | 4.000 |

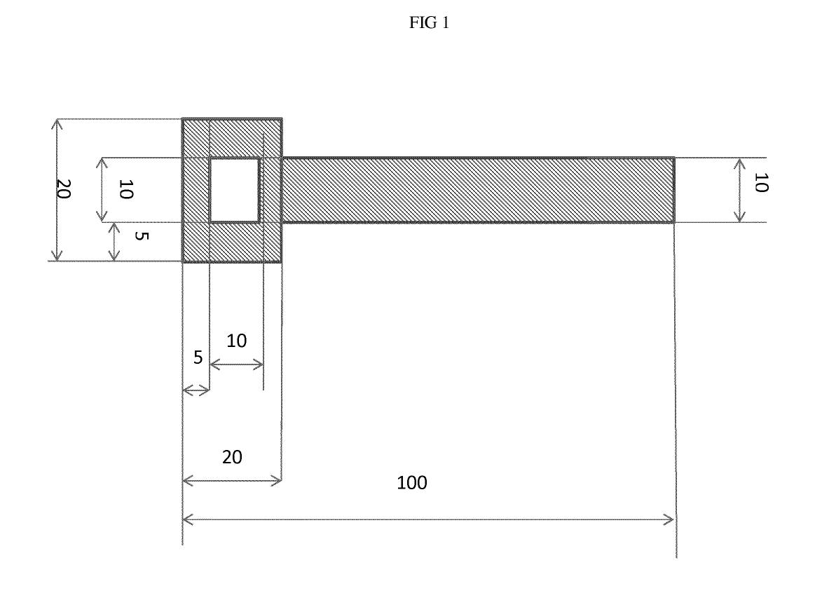

The printed sample is shown in FIG. 1. For each filament, 5 printer tests were carried out. The print was stopped when one side of the object was detached from the plane, thereby preventing the print of the object. The results are reported in Table 1.

TABLE 1

| | height before detach |
|---|---|
| | (Z) (mm) (average |
| material | measure) |
| PP1* | 0.8 |
| PP2* | 1.2 |
| PP3 | full (5 mm) |

*comparative

What is claimed is:

1. A filament for use in an extrusion-based additive manufacturing system comprising:
a propylene ethylene copolymer having:
ethylene derived units content ranging from 3.0 wt % to 12.0 wt %, based upon the weight of the propylene ethylene copolymer;
MFR L (Melt Flow Rate according to ISO 1133, condition L, at 230° C. and 2.16 kg load) from 4 to 20 g/10 min; and
xylene solubles measured at 25° C. from 3 wt % to 30 wt %, based upon the weight of the propylene ethylene copolymer.

2. The filament according to claim 1, wherein, in the propylene copolymer, the ethylene derived units content ranges from 3.5 wt % to 10.0 wt %, based upon the weight of the propylene ethylene copolymer.

3. The filament according to claim 1, wherein the propylene copolymer has a MFR L ranging from 5 to 10 g/10 min.

4. The filament according to claim 1, wherein, in the propylene copolymer, the xylene solubles measured at 25° C. is from 4 wt % to 25 wt %, based upon the weight of the propylene ethylene copolymer.

5. The filament according to claim 1, wherein, in the propylene copolymer, the ethylene derived units content ranges from 3.8 wt % to 8.0 wt %, based upon the weight of the propylene ethylene copolymer.

6. The filament according to claim 1, wherein the propylene copolymer has a MFR L ranging from 6 to 8 g/10 min.

7. The filament according to claim 1, wherein the filament has a constant diameter having a variation of +/−0.05 mm.

8. The filament according to claim 1, wherein the filament has a constant diameter having a variation of +/−0.03 mm.

9. The filament according to claim 1, wherein the filament has a diameter selected from the group consisting of (a) 1.75 mm+/−0.05 mm and (b) 3 mm+/−0.05 mm.

10. The filament according to claim 1, wherein the filament has a diameter selected from the group consisting of (a) 1.75 mm+/−0.03 mm and (b) 3 mm+/−0.03 mm.

11. (canceled)

12. An extrusion-based additive manufacturing system comprising:
(I) a filament comprising
(A) a propylene ethylene copolymer having:
ethylene derived units content ranging from 3.0 wt % to 12.0 wt %, based upon the weight of the propylene ethylene copolymer;
MFR L (Melt Flow Rate according to ISO 1133, condition L, at 230° C. and 2.16 kg load) from 4 to 20 g/10 min; and
xylene solubles measured at 25° C. from 3 wt % to 30 wt %, based upon the weight of the propylene ethylene copolymer.

13. A 3D printed article prepared from an extrusion-based additive manufacturing system comprising:
(I) a filament comprising
(A) a propylene ethylene copolymer having:
ethylene derived units content ranging from 3.0 wt % to 12.0 wt %, based upon the weight of the propylene ethylene copolymer;
MFR L (Melt Flow Rate according to ISO 1133, condition L, at 230° C. and 2.16 kg load) from 4 to 20 g/10 min; and
xylene solubles measured at 25° C. from 3 wt % to 30 wt %, based upon the weight of the propylene ethylene copolymer.
